(19) United States
(12) Patent Application Publication
(10) Pub. No.: US 2003/0042385 A1
(43) Pub. Date: Mar. 6, 2003

(54) Liquid crystal display with a ball-and-socket mounting joint

(75) Inventors: Chien-Ju Hung, Taoyuan (TW); Yi Chang Lu, Chung-Li City (TW)

Correspondence Address: INTELLECTUAL PROPERTY SOLUTIONS, INCORPORATED, 5717 COLFAX AVENUE, ALEXANDRIA, VA, 22311, US

(73) Assignee: HANNSTAR DISPLAY CORP., Taipei (TW)

(21) Appl. No.: 10/051,072

(22) Filed: Jan. 22, 2002

(30) Foreign Application Priority Data
Aug. 30, 2001 (TW) 90214890

(51) Int. Cl. A47G 29/00; F16M 11/02

(52) U.S. Cl. 248/371; 248/181.1; 248/922

(57) ABSTRACT

A liquid crystal display with a ball-and-socket mounting joint is provided. The liquid crystal display comprises a display body, a ball-and-socket mounting joint and a base. The ball-and-socket mounting joint is disposed on the display body. The base is connected with the display body via the ball-and-socket mounting joint so that the display body is rotatably disposed on the base. Thus, the liquid crystal display can rotate smoothly with a simpler structure and at a lower cost.

### BACKGROUND OF THE INVENTION

1. Field of the invention

The invention relates to a liquid crystal display; in particular, the invention relates to a liquid crystal display with a ball-and-socket mounting joint.

2. Description of the related art

Referring to FIG. 1a and FIG. 1b, a conventional liquid crystal display 10 comprises a display body 11, a base 14, a support 15 and a hinge 16.

The display body 11 mainly consists of a liquid crystal display panel, a rear case and a front case (not labeled). The rear case of the display body 11 is connected with the support 15 via the hinge 16. The support 15 is disposed on the base 14 in a rotatable manner.

As stated above, the display body 11 is connected with the base 14 via the hinge 16 and the support 15 so that the display body 11 can rotate in X direction as shown in FIG. 1a and in Y direction as shown in FIG. 1b relative to the base 14. However, if the conventional liquid crystal display is to rotate in two directions, it must be provided with the complicated structure shown in FIG. 1a and FIG. 1b.

In addition, it is noted that most conventional liquid crystal displays cannot rotate in two directions; that is, most of them simply rotate in one direction. For example, the display body is fixed at the base via a hinge or a support. Although this fixing manner is simpler, it cannot meet the requirements of most users.

### SUMMARY OF THE INVENTION

In order to address the disadvantages of the aforementioned liquid crystal display, the invention provides a liquid crystal display that can rotate smoothly with a simpler structure and at a lower cost.

Accordingly, the invention provides a liquid crystal display with a ball-and-socket mounting joint. The liquid crystal display comprises a display body, a ball-and-socket mounting joint and a base. The ball-and-socket mounting joint is disposed on the display body. The base is connected with the display body via the ball-and-socket mounting joint so that the display body is rotatably disposed on the base.

Furthermore, the ball-and-socket mounting joint comprises a socket, a ball, a connecting member and at least one first elastic member. The ball is rotatably disposed in the socket. The connecting member is connected with the ball. The first elastic member is disposed at the socket so as to contact the ball.

In a preferred embodiment, the liquid crystal display further comprises a combining member and an arm. The combining member, for fixedly disposing the socket at the display body, is disposed at the display body. The arm connects the connecting member and the base.

Furthermore, the combining member comprises a cover and at least one screw. The ball-and-socket mounting joint further comprises at least one second elastic member. The second elastic member is disposed between the cover and the socket so as to contact the ball.

In the preferred embodiment, the second elastic member is a spring or a damper provided with a high damping coefficient.

### BRIEF DESCRIPTION OF THE DRAWINGS

The invention is hereinafter described in detail with reference to the accompanying drawings in which:

FIG. 1a is a perspective view depicting a conventional liquid crystal display;

FIG. 1b is a side view depicting the liquid crystal display as shown in FIG. 1a;

FIG. 2a is an exploded view depicting a liquid crystal display as disclosed in this invention;

FIG. 2b is a perspective view depicting the liquid crystal display as shown in FIG. 2a;

FIGS. 3a-3b are cross-sections depicting a display body and a ball-and-socket mounting joint as shown in FIG. 2a;

FIG. 4a is a cross-section depicting the ball-and-socket mounting joint disposed at the display body as shown in FIG. 2a, wherein elastic members are disposed between a socket and a ball; and

FIGS. 4b-4c are cross-sections depicting the ball-and-socket mounting joint disposed at the display body as shown in FIG. 2a, wherein the elastic member is disposed between a cover and a ball.

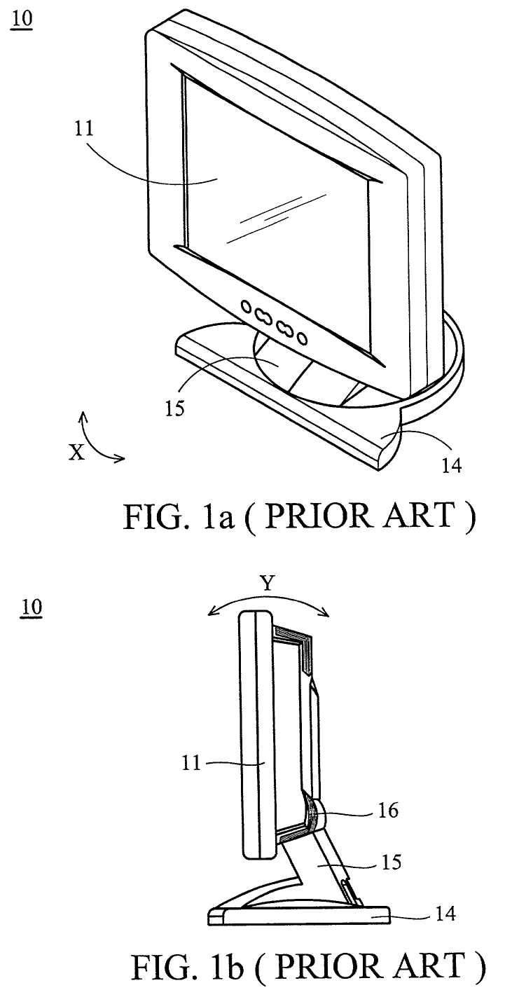

### DETAILED DESCRIPTION OF THE INVENTION

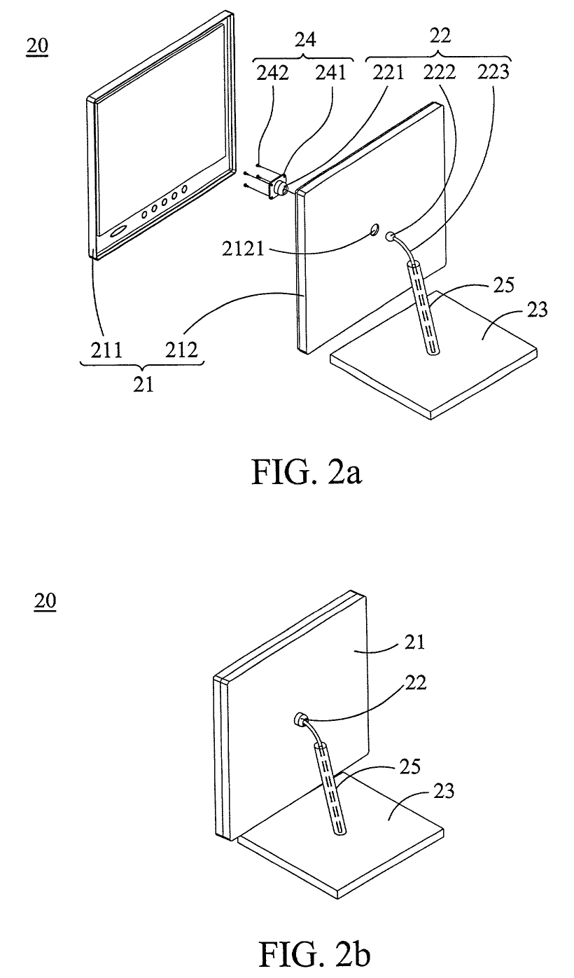

Referring to FIG. 2a and FIG. 2b, a liquid crystal display 20, as disclosed in this invention, comprises a display body 21, a ball-and-socket mounting joint 22, a base 23, a combining member 24 and an arm 25.

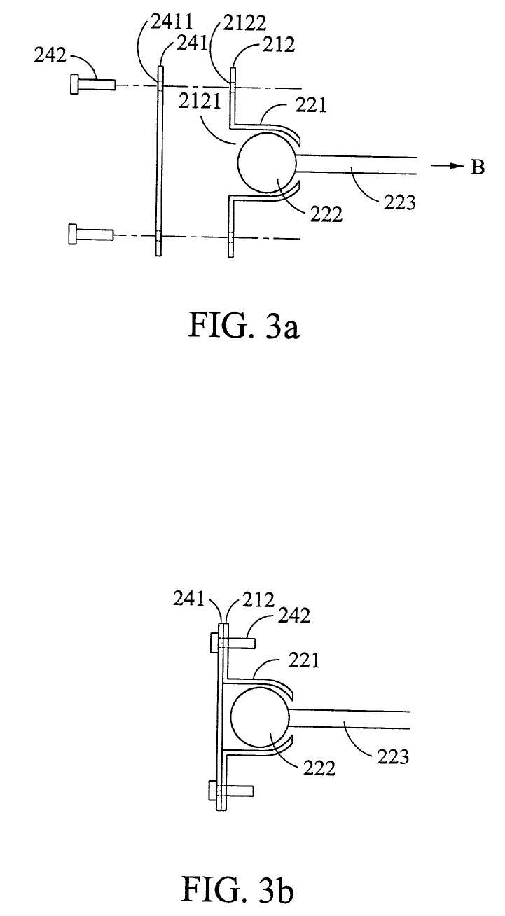

As shown in FIG. 2a, the display body 21 comprises a front case 211 and a rear case 212. An unillustrated liquid crystal display panel is disposed between the front case 211 and the rear case 212. The rear case 212 is provided with a first through hole 2121 and plural screw holes 2122, referring to FIG. 3a.

As shown in FIG. 3a and FIG. 3b, the ball-and-socket mounting joint 22 is disposed on the display body 21. The ball-and-socket mounting joint 22 comprises a socket 221, a ball 222 and a connecting member 223. The ball 222 is rotatably disposed in the socket 221. The connecting member 223 is connected with the ball 222. The connecting member 223 passes through the first through hole 2121 of the rear case 212 along an arrow B in FIG. 3a so that the ball 222 is disposed inside the socket 221.

The base 23 is connected with the display body 21 via the arm 25 and the ball-and-socket mounting joint 22 so that the display body 21 is rotatably disposed on the base 23. The arm 25 connects the connecting member 223 of the ball-and-socket mounting joint 22 and the base 23.

As shown in FIG. 2a and FIG. 3a, the combining member 24, for fixedly disposing the socket 221 of the ball-and-socket mounting joint 22 at the rear case 212 of the display body 21, is disposed at the display body 21. The combining member 24 comprises a cover 241 and plural screws 242. The cover 241 is provided with plural second through holes 2411. The screws 242 screw into the screw holes 2122 of the rear case 212 through the second through holes 2411 so that the cover 241 fixes the socket 221 of the ball-and-socket mounting joint 22 at the rear case 212 of the display body 21, referring to FIG. 3b.

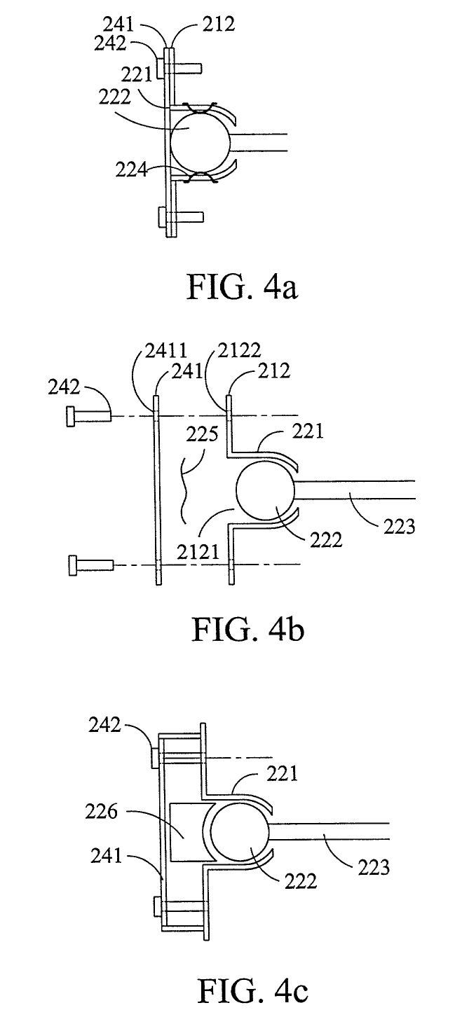

In addition, as shown in FIG. 4a, the ball-and-socket mounting joint 22 may comprise two first elastic members 224. Each of the first elastic members 224 is disposed at the socket 221 so as to contact the ball 222. Thus, when the ball 222 rotates inside the socket 221, the first elastic members 224 adjust the torque of the ball 222 by its spring force. Also, the torque of the ball 222 may be adjusted by the frictional coefficient between the ball 222 and the first elastic members 224. The first elastic members 224 may be formed as a stripe.

Furthermore, as shown in FIG. 4b, the ball-and-socket mounting joint 22 may comprise a second elastic member 225 that is a spring. The second elastic member 225 is disposed between the cover 241 and the socket 221 so as to contact the ball 222. Thus, the torque of the ball 222 may be adjusted by the second elastic member 225.

In addition, as shown in FIG. 4c, the ball-and-socket mounting joint 22 may comprise a second elastic member 226 that is a damper. It is provided with high damping coefficient. The damping coefficient of the damper is adjusted by compression. Such compression is adjusted by the length of the cover 241 and the width of the damper. The second elastic member 226 is disposed between the cover 241 and the socket 221 so as to contact the ball 222. Thus, the torque of the ball 222 may be adjusted by the second elastic member 226.

It is noted that the torque of the ball 222 may be adjusted by the ball-and-socket mounting joint 22 itself when there is no elastic member. Specifically, the surface, contacting the ball 222, of the socket 221 is roughened so that a friction can be generated between the socket 221 and the ball 222. Thus, the torque of the ball 222 may be adjusted by the ball-and-socket mounting joint 22 itself.

As stated above, since the liquid crystal display is provided with the ball-and-socket mounting joint, it can rotate in two directions under a simpler structure. That is, the liquid crystal display, as disclosed in this invention, can rotate smoothly with a simpler structure and at a lower cost.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A liquid crystal display comprising:
a display body;
a ball-and-socket mounting joint disposed on the display body; and
a base connected with the display body via the ball-and-socket mounting joint so that the display body is rotatably disposed on the base.

2. The liquid crystal display as claimed in claim 1, wherein the ball-and-socket mounting joint comprises:
a socket;
a ball rotatably disposed in the socket; and
a connecting member connected with the ball.

3. The liquid crystal display as claimed in claim 2, further comprising:
a combining member, for fixedly disposing the socket at the display body, disposed at the display body; and
an arm connecting the connecting member and the base.

4. The liquid crystal display as claimed in claim 3, wherein the combining member comprises a cover and at least one screw.

5. The liquid crystal display as claimed in claim 2, the ball-and-socket mounting joint further comprising:
at least one first elastic member disposed at the socket so as to contact the ball.

6. The liquid crystal display as claimed in claim 2, the ball-and-socket mounting joint further comprising:
at least one second elastic member disposed between the cover and the socket so as to contact the ball.

7. The liquid crystal display as claimed in claim 6, wherein the second elastic member is a spring.

8. The liquid crystal display as claimed in claim 6, wherein the second elastic member is a damper.

9. The liquid crystal display as claimed in claim 8, wherein the damper is provided with high damping coefficient.
